(19) United States
(12) Patent Application Publication
(10) Pub. No.: US 2009/0027294 A1
(43) Pub. Date: Jan. 29, 2009

(54) OMNI-DIRECTIONAL ANTENNA FOR MOBILE SATELLITE BROADCASTING APPLICATIONS

(75) Inventors: Mathieu Bourry, Lausanne (CH); Ferdinando Tiezzi, Renens (CH); Stefano Vaccaro, Gland (CH)

Correspondence Address: GRIFFIN & SZIPL, PC, SUITE PH-1, 2300 NINTH STREET, SOUTH, ARLINGTON, VA, 22204, US

(73) Assignee: JAST SA, Ecublens (CH)

(21) Appl. No.: 12/179,026

(22) Filed: Jul. 24, 2008

Related U.S. Application Data
(60) Provisional application No. 60/951,819, filed on Jul. 25, 2007.

(51) Int. Cl. H01Q 1/48; H01Q 1/38

(52) U.S. Cl. 343/848; 343/700 MS

(57) ABSTRACT

An antenna for mobile satellite communication is disclosed. The antenna may include an electrically conducting ground plane and at least a first and a second radiating element. Each one of the radiating elements may be electrically coupled to a feed line, whereby each one of said at least first and second radiating elements may be electrically connected to the ground plane at one end and being open-circuit at an opposite end, whereby the at least first and second radiating elements may intersect at a feeding point of the feed line and extend radially with respect to the elongation of the feed line.

### BACKGROUND OF THE INVENTION

The invention generally relates to an antenna for vehicular mobile applications using mobile satellite systems, and more particularly, to a multiple planar inverted F-antenna with a conical radiation pattern with high directivity in the range of low elevation angle above the horizon. The invention is pre-dominantly related to be designed for but not limited to a car-roof antenna for satellite communications.

In recent years, many new satellite based services for vehicular applications have come into service. These services include applications such as satellite communications or global positioning systems. Compact antennas, generally arranged on the top of a vehicle are required to receive these kinds of services together with traffic- and emergency- or security information data. These services are not only likely to be operated at different frequencies but also the radiation pattern requirements for the antenna may vary.

For example, telecommunication may be provided via geostationary satellite systems requiring antenna beams pointing at an elevation between 20° and 60° at European latitudes while global positioning systems require antenna beams at zenith elevation.

The development of effective vehicular front-ends requires antennas with high directivity at the desired elevation angle, with a thin geometric profile, with a lightweight and low-cost design and being conformable on curved surfaces.

Due to the characteristics of geostationary satellite broadcasting, receiving antennas must have their maximum directivity at an elevation angle which depends on the latitude. Moreover, in modern broadcasting systems, the satellite coverage is some times supported by terrestrial repeaters, in particular in those urban areas, where buildings may prevent a line-of-sight to a satellite and in which the satellite signal is not sufficiently available. Such a terrestrial repeater, even if positioned at a certain elevation above ground level, e.g. in a tower, can only be tracked at a very low elevation angle, typically between 50 to 15° of elevation, by means of a receiver being located on a vehicle.

Generally, microstrip or printed antennas, in particular planar inverted F-antennas (PIFA) provide a rather omni-directional radiation pattern, which is typically not sufficiently symmetric with respect to azimuth (angle φ) variations. Hence, PIFA antenna designs have drawbacks with respect to requirements of mobile satellite systems. In particular, the fairly broad coverage limits the maximum value of the antenna directivity. For instance, a perfect omni-directional antenna laying on an infinitely expanding ground plane will have a maximum theoretical directivity of 3 dB in any direction.

Another drawback is that the variation of the level of the directivity in Azimuth causes a degree of the reception quality depending on the orientation of the vehicle, on which the antenna is mounted.

Other antenna types, such a patch antennas, PIFA compact antennas, ¾ and ¼ of wave length antennas, monopole antennas, dipole antennas, and disc antennas also have common drawbacks, in particular when a very small size of the antenna is required.

Whereas patch antennas have sizes in the order of half wave lengths, the PIFA compact antennas have maximal dimensions under this limit with a good matching to the input impedance. Nevertheless, the performances are generally affected in far field by the lower directivity due to the reduced effective aperture area of the small antenna. Moreover, even if the small antenna design has a radiation pattern and a directivity being rather independent on the frequency, their impedance matching is very difficult, because the resistance and reactance of the antenna is still very sensitive to the frequency and has generally a higher quality (Q) factor. This means, that the radiating element has a behaviour that is close to one of a resonator. Reducing the size leading to a higher Q-factor implies a smaller bandwidth in frequency.

Finally, high Q-factor and narrow bandwidth give more super-directive antennas, which are not desired for the present application purpose.

Various antenna types mentioned above do not provide optimal efficiency, in particular, when applied to the reception of signals broadcasted by geostationary satellites, requiring a maximum directivity in the range of 20° to 60° of elevation (angle α).

Some antennas and antenna systems as known in the prior art often have a reduced gain. Their radiation pattern is often not sufficiently symmetric or it is too directive in broadside directions or horizontal directions. Also, small and compact antennas typically comprise a small bandwidth, which it is difficult to match.

Their radiation pattern resembles a monopole and is often not suitable for low elevation transmission and broadcasting. Alternatively, the radiation pattern may resemble dipole, providing a horizontal pattern but generally lacks symmetry due to the design that influences the near field of the antenna.

Moreover, the general radiation pattern of the antenna is very sensitive to the environment, because it is closely linked to the near field properties.

Furthermore, in order to reduce the overall size of an antenna, dielectric materials with a dielectric permittivity larger than one (permittivity of free space and air) must be applied. However, usage of dielectric materials always comes along with inevitable losses, leading to a decrease of the antenna's efficiency. Furthermore, the application of dielectric materials increases the manufacturing costs.

### BRIEF SUMMARY OF THE INVENTION

The present invention provides an antenna for mobile satellite communication.

The antenna according to the invention is designed as omni-directional compact antenna for mobile satellite communication and includes an electrically conducting ground plane and comprises at least a first and a second radiating element. Both at least the first and the second radiating elements are electrically coupled to a feed line. Further, each one of the at least first and second radiating elements are disposed at a distance from the ground plane and they are electrically connected to the ground plane with an end section, whereas at an opposite end, each one of said at least first and second radiating elements is open-circuit.

Further, the at least first and second radiating elements intersect each other at a feeding point of the feed line. Hence, the at least two radiating elements cross each other at a position determined by the feed line. Additionally, the at least first and second radiating elements extend non-parallel with respect to each other. In particular, they extend in radial direction with respect to the elongation of the feed line.

This antenna design comprising at least two radiating elements, each of which is electrically coupled to the ground plane with one and section and being open-circuit at an opposite end section and being further electrically connected with a feeding source at a mutual intersection is suitable for the simultaneous reception of two different broadcasting systems, namely satellite broadcasting and broadcasting provided by terrestrial repeaters.

The suggested antenna design is suitable for a mobile satellite system requiring a receiving and or transmitting antenna omni-directional in azimuth. It is adapted to provide a directivity larger than 4 dBil for elevation angles between 20° to 60°, while maintaining a sufficient and good level of directivity larger than −3 dBil between 5° to 15° of elevation.

The applied techniques and the choice of dielectric layer material can be accordingly designed in order to modify the shape of the radiation pattern, in particular to modify the elevation angle, at which the maximum of the directivity can be obtained.

A major advantage of the inventive antenna design is that it allows to minimize the directivity at a very high elevation angle, in particular between 70° and 90°, hence closed to zenith direction. Further, it allows to minimize the directivity at very low elevation angles, less than 5°, which is close to the horizon, which are directions, where no signal of interest is present or where the signal does not require a significant directivity. By minimizing the radiation pattern in these particular directions close to zenith and horizon, allows to increase the level of directivity at the intermediate directions, in particular between 20° and 60°.

According to another embodiment, the at least first and second radiating elements comprise an identical geometric shape. The radiating elements are further oriented at an angle with respect to each other, whereby the feed line serves as axis of rotation.

Consequently, the radiating elements extend transverse to the elongation of the feed line. Hence, the angle between any one of the radiating elements and the feed line substantially equals 90°.

In some embodiments, the various radiating elements are arranged and oriented in a regular manner with a feeding point of the feed line as symmetry axis. Moreover, it is intended, that a relative angle between any two adjacently disposed radiating elements equals 180° divided by the number of radiating elements.

For instance, if the total number of intersecting radiating elements equals 2, the relative angle between intersecting portions of these two radiating elements which are either opened circuit or coupled to the ground plain equals 90°. If three radiating elements are provided, this angle between adjacently arranged radiating elements will reduced to 60°. If the number of radiating elements equals four, the relative angle will reduce to 45° and so on.

However, the number of radiating elements of identical shape and geometry may vary from two to three, four, five, six, seven or even more, whereby the total number depends on the underlying transmission technology and frequency, which determine the limit of widths of each radiating element. Further, the number of mutually rotated and duplicated radiating elements is selected in terms of providing a good behaviour with respect of matched input impedance and with respect to a desired radiation pattern.

However, for a good and sufficient symmetry in azimuth, usage of three identical radiating elements seems to be beneficial providing probably the best compromise between symmetric radiation pattern and the number of radiating element. Increasing the number of used radiating elements, which may be designed as transmission lines will end up in a single planar conducting structure with a reduced degree of freedom for the overall antenna design.

In typical embodiments, all radiating elements that are typically designed as transmission lines extend substantially parallel to the ground plane. In some embodiments, all radiating elements extend in a common plane parallel to the ground plane. Consequently, the feed line extends parallel to the surface normal of the ground plane as well as parallel to the plane comprising the radiating elements.

According to a further embodiment, the feed line is fed by means of a waveguide being etched in the ground plane or by means of a microstrip line, which extends substantially parallel to the ground plane, above or below the ground plane.

Particularly, in such embodiments, where the feed line is fed by means of a microstrip line extending below the ground plane, the feed line and/or the microstrip line extend through an aperture of the ground plane.

Moreover, according to another embodiment, the at least first and second radiating elements comprise an enlarging outer dimension or a diverging shape in the region of their open-circuit end portion compared to the opposite end portion being electrically connected to the ground plane. In this way, the resonance frequency of the antenna can be modified without increasing its transverse size. Moreover, the profile of any radiating element can be tapered to reduce the reflexions in a transition to the enlarged part of the open ended radiating element.

Additionally or alternatively, the open-circuit end portion of the radiating elements may extend at an angle with respect to the elongation of the residual radiating element portion and/or with respect to the ground plane. For instance, the open-circuit end portion may be bended and may extend parallel to the elongation of the feed line. Hence, this bended end portion may extend vertical with respect to the residual portion of the respective radiating element.

According to another embodiment of the invention, the space between the ground plane and the at least first and second radiating elements is filled with an at least first dielectric layer. The dielectric layer typically comprises a relative permittivity εr larger than 1. In this way, the overall size of the antenna can be reduced. Generally, any type of the dielectric material can be used as a substrate to be disposed at least between the various radiating elements and the ground plane. However, usage of materials with a very high permittivity will lead to a generalized loss of efficiency of the antenna.

Additionally, also at least a second dielectric layer may be disposed adjacent to an upper surface of the radiating elements, which faces away from the ground plane. In this way, the radiating elements may be sandwiched between first and second dielectric layers. The first and second dielectric layers may comprise the same or different dielectric materials with the same or different dielectric permittivity, respectively. However, each one of the dielectric layers either on top or below the radiating elements or above or below the ground plane may comprise a homogeneous or inhomogeneous structure. For instance, each dielectric layer may comprise a stack-like structure of a multiplicity of sub-layers.

Hence, instead of a homogeneously designed dielectric layer, also a multilayer dielectric can be applied and disposed between, on top or below the various radiating elements and the ground plane.

Furthermore, it is conceivable that the ground plane and/or the various radiating elements are entirely embedded in a dielectric layer, with respect to either direction.

Further, any dielectric layer, irrespective whether its size is in the range of the geometric dimensions of the feed line and/or of the size of the radiating elements, may comprise a cylindrical, circular and/or polygonal shape. Also, the ground plane may have a disc-like round, rectangular or polygonal shape. However, also other shapes and designs of a ground plane and dielectric layers, such as a rectangular, quadratic or cubic design is within the scope of the present invention.

The material to be used for the ground plane and/or for the radiating elements may be copper, whereas the material for a dielectric layer may comprise polypropylene or comparable plastic materials. Additionally, in particular for optional dielectric layers polycarbonate as well as acrylonitrile butadiene styrene (ABS)-based plastic materials are also applicable.

Furthermore, the electrical connection between the radiating elements connecting one free end of the radiating elements with the ground plane is designed as a vertical interconnect access (VIA). Such electrical interconnects may further be embedded in the at least first dielectric layer. Alternatively, they may be adapted to laterally confine the first dielectric layer. In other words, the dielectric layer or substrate can be shaped according to the lateral confinement provided by the conducting transmission lines connecting a lateral end portion of the radiating elements to the ground plane.

Additionally, smart antenna designs can be obtained by introducing active electrical elements in order to orientate the radiation pattern in the direction of a most effective source of broadcasting. Such an active modification may be applied in the radiating element itself, for example on the sides of the antenna for minimizing aperture elevation of the radiation pattern by adding a PIN diode, that will control the connecting to the ground. Alternatively, also a FET or other types of high frequency (e.g: HEMT, nanotubes structures) transistors could be implemented. In variants, the active electrical elements could have different functions in the system when connected directly to the “grounding Via”. It could work from the simple “switching” function or as modulator (variable grounding impedance) of the far field pattern to increase the power (TX)/sensitivity (RX) in one direction as presented above but also as preamplifier since the signal can also be “collected” from the “grounding” parts.

Generally, the described antenna and the antenna design is applicable to various types of antennas, such as patch antennas, PIFA compact antennas, ¾ and ¼ of wavelengths antennas, monopole antennas, dipole antennas and disc-type antennas.

### BRIEF DESCRIPTION OF THE SEVERAL VIEWS OF THE DRAWINGS

The foregoing and additional objects, features and advantages of the present invention will be more readily apparent and described in the following detail description by making reference to the a accompanying drawings, in which:

FIG. 1 schematically illustrates a perspective view of an antenna assembly according to a first embodiment of the present invention,

FIG. 2 depicts a comparable illustration of an antenna assembly according to a second embodiment,

FIG. 3 shows in a cross sectional illustration an embodiment with two dielectric layers,

FIG. 4 shows another embodiment in cross section,

FIG. 5 illustrates an embodiment with a transmission line sandwiched between two different dielectric layers,

FIG. 6 shows a further modification of the embodiment according to FIG. 4,

FIG. 7 shows a cross sectional illustration of an embodiment with a microstrip line extending below the ground plane and

FIG. 8 illustrates a microstrip line coupled to the feed line above the ground plane.

FIG. 9 shows a top view illustration of an antenna design comprising three radiating elements,

FIG. 10 gives a perspective illustration of the embodiment according to FIG. 9,

FIG. 11 in a top view illustration shows another embodiment comprising three transmission lines,

FIG. 12 depicts the embodiment according to FIG. 11 in a perspective view,

FIG. 13 shows a cross sectional illustration of the embodiment according to FIGS. 11 and 12,

FIG. 14 schematically illustrates a design with modified open ended radiating elements,

FIG. 15 depicts three intersecting radiating elements having a T-shaped termination,

FIG. 16 shows another modified open ended portion with a diverging shape.

FIG. 17 illustrates a radiation pattern along a polar cut (φ=0°),

FIG. 18 gives a radiation pattern along a polar cut (φ=90°),

FIG. 19 depicts the radiation pattern along a conical cut (with constant θ=65°) and

FIG. 20 schematically illustrates a 3D-radiation pattern at a 10 dB scale.

### DETAILED DESCRIPTION OF THE INVENTION

The present invention aims to provide an antenna for mobile satellite communication providing a maximum coverage at an elevation ranging between 20° to 60°, while still ensuring a good level of directivity at a range of 5° to 15° of elevation in order to receive signal broadcasting by terrestrial repeaters. Further, the antenna according to the present invention may be able to receive simultaneously a vertically polarized signal at 5° to 15° of elevation and a dual circularly polarized signal at 20° to 60° of elevation.

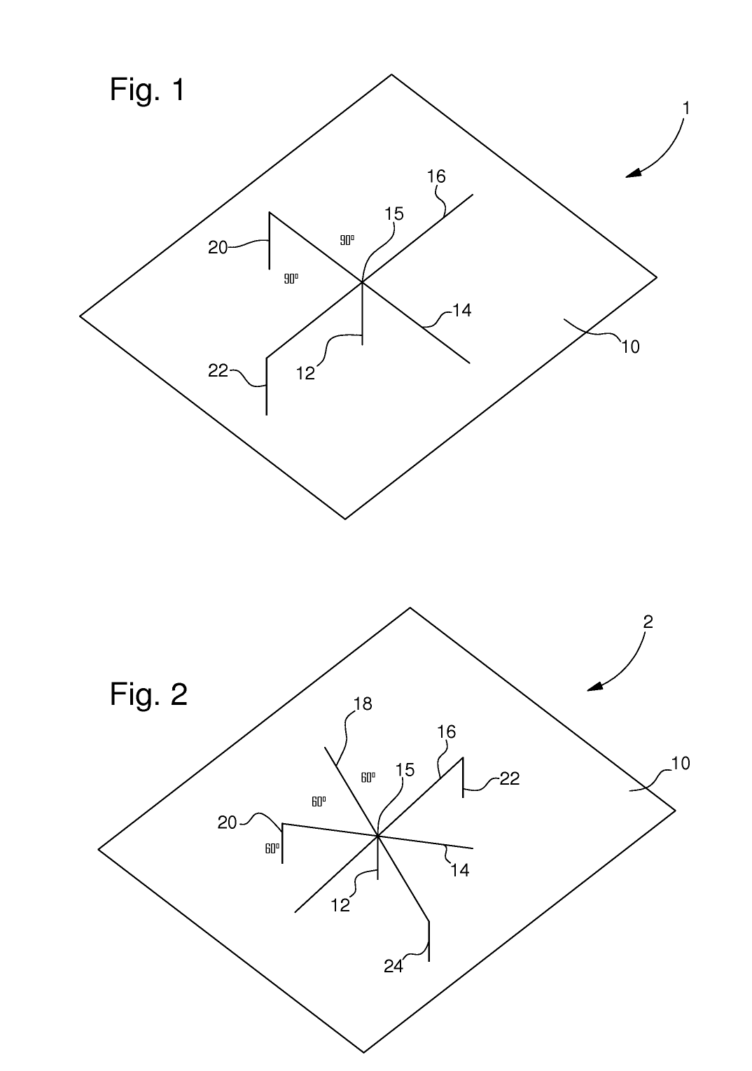

The antenna 1 according to FIG. 1 comprises a ground plane 10 and a first radiating element 14 as well as a second radiating element 16. The two radiating elements 14, 16 are designed as transmission lines. They both intersect at a feeding point 15 that coincides with an end section of the feed line 12 extending substantially parallel to the surface normal of the ground plane 10.

In this embodiment, the two transmission lines 14, 16 extend at an angle of 90° with respect to each other. They both extend in a plane substantially parallel to the ground plane 10. The separation between these two planes is governed by the elongation or extension of the feed line 12. Additionally, each one of the radiating elements 14, 16 is coupled and connected to the ground plane 10 by means of a vertically extending electrical coupling element 20, 22, which is typically designed as vertical interconnect access (VIA).

The antenna 2 as illustrated in FIG. 2 comprises three radiating elements 14, 16, 18, each of which being substantially identical in shape. Also here, each one of these radiating elements 14, 16, 18 is vertically connected to the ground plane 10 by means of VIA 20, 22, 24, respectively. Further, all radiating elements 14, 16, 18 are electrically coupled to the feed line 12, the upper end section of which being designed as feeding pin 15.

Any one of the radiating elements 14, 16, 18 at its end opposite to the VIA 20, 22, 24 are opened-circuit or open ended.

As can further be seen from the illustrations of FIG. 1 and FIG. 2, the relative angle orientation between adjacently disposed radiating elements is governed by 180° divided by the number of elements. For instance, the relative angle between adjacently disposed components of the intersecting radiating elements 14, 16 equals 90°, whereas the relative angle between adjacently disposed radiating elements 14, 16, 18 according to FIG. 2 equals 60°. For instance, the angle between that portion of the radiating element 18 comprising VIA 24 and the neighbouring open-circuit portion of the radiating element 14 in FIG. 2 equals 60°. However, since the various radiating elements 14, 16, 18 comprise different end sections, in their configuration according to FIG. 2 they have to be rotated by 120° in order to congruently overlap.

Hence, the angle between that portion of the radiating element 14 comprising VIA 20 and that portion of the radiating element 18 comprising VIA 24 equals 120°. Similarly, radiating element 16 would have to be rotated clockwise by 120° in order to overlap with radiating element 18.

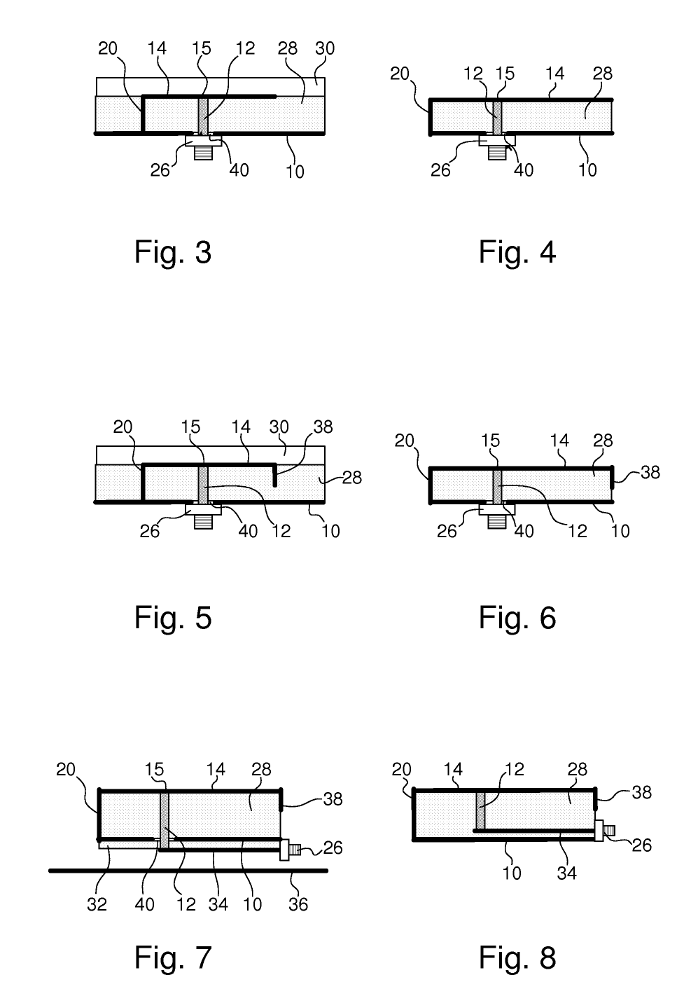

The illustrations according to FIGS. 3 to 8 show various embodiments on how to embed or on how to provide different layers of dielectric materials to the provided antenna design.

The embodiments according to FIGS. 3 to 6 have in common, that a port 26, which can be coupled to any type of coaxial cable one side and which can be directly coupled to the feed line 12 with an opposite side, extends through an aperture 40 of the ground plane 10. In the embodiments according to FIGS. 7 and 8, this port 26 is disposed below the ground plane 10 but it is oriented in lateral direction, hence parallel to the ground plane. The electrically coupling between the port 26 and the feeding source 12 is provided by means of a microstrip line 34 extending below the ground plane 10 as illustrated in FIG. 7. Alternatively, the microstrip line 34 may also extend coplanar to the ground plane 10 above the ground plane, as schematically illustrated in FIG. 8.

Furthermore, a first dielectric layer 28 is disposed between the transmission line 14 and the ground plane 10 in the embodiments according to FIGS. 3 to 6. Further, in the embodiments according to FIGS. 3 to 5 also on top of the transmission line 14, there is provided an additional dielectric cover layer 30, which may comprise another dielectric material. In some embodiments, the dielectric material for the layer 28 comprises polypropylene or comparable plastic materials, whereas the optional layer 30 may comprise polycarbonate or ABS types of plastic or plastic components.

In the embodiment according to FIG. 4, the dielectric layer 28 is entirely encompassed by the vertically extending VIA 20 and the horizontally extending ground plane 10 and the transmission line 14. The embodiment according to FIG. 6 differs from the embodiment according to FIG. 4 in that the open-circuit end of the transmission line 14 comprises an end section 38 which is bended and which extends vertically towards the ground plane 10.

Compared to the embodiments according to FIGS. 4 and 6, the antenna designs according to FIGS. 3 and 5, differ only with respect to the lateral size of the ground plane 10 and the lateral size of the dielectric substrate or layer 28.

In these embodiments, the transmission line 14 and its associated VIA 20 are entirely embedded in the dielectric layers 28, 30. Also, according to the embodiments of FIGS. 3 and 5, the lateral extension of the ground plane 10 exceeds the lateral extension of the transmission line 14.

In the embodiment according to FIG. 7, also the ground plane 10 is entirely embedded in dielectric material. Here, a dielectric layer 28 is disposed between a ground plane 10 and the transmission line 14, whereas an additional dielectric layer 32 is disposed below the ground plane 10, where it further serves as a spacer or distance piece between the microstrip 34 and the ground plane 10.

Further, the additionally illustrated layer 36 may be representative of a layer referring to the environment in a respective application scenario. For instance, the layer 36 may represent a vehicle outer surface.

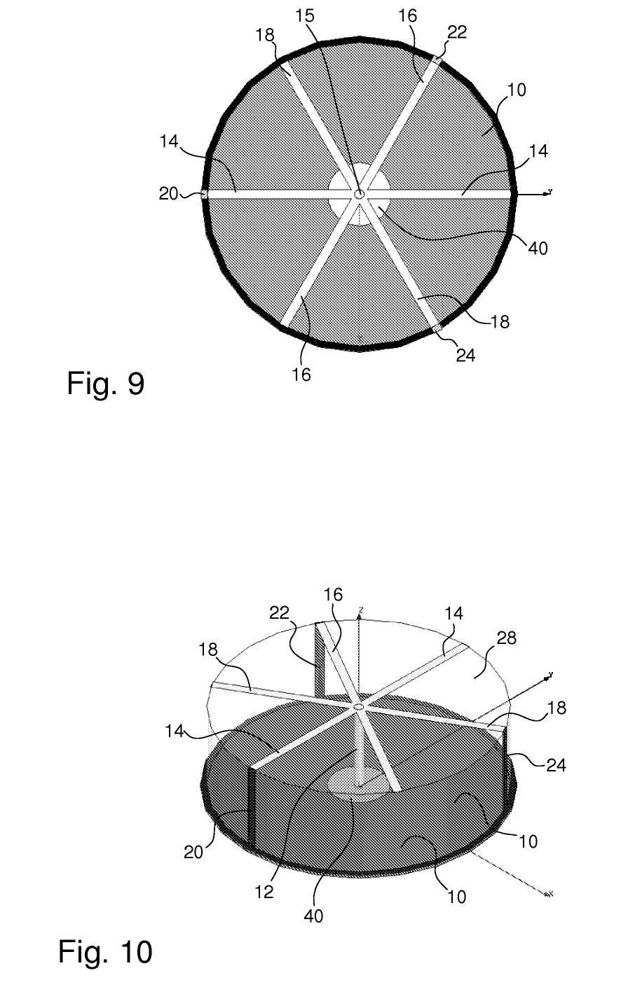

The somewhat more detailed illustrations according to FIGS. 9 and 10 substantially correspond to the configuration of the embodiment according to FIG. 2. The various transmission lines 14, 16, 18 are arranged regularly in a staggered manner with the feeding point 15 as intersection point and with the feed line 12 as axis of rotation.

As can be clearly seen, the space between the transmission lines 14, 16, 18 and the ground plane 10 is entirely filled with a layer of the electric material 28. The layer or substrate 28 has a disc- or cylindrical-like polygonal shape. The lateral expansion of the substrate 28, the various transmission lines 14, 16, 18 and the lateral expansion of the ground plane 10 are substantially equal. The various VIA 20, 22, 24 providing an electric coupling of an end portion of respective transmission lines 14, 16, 18 extend at the outer lateral surface of the substrate 28.

The various transmission lines 14, 16, 18 and associated vertical interconnects 20, 22, 24 may comprise a single peace metallic structure, e.g. made of copper.

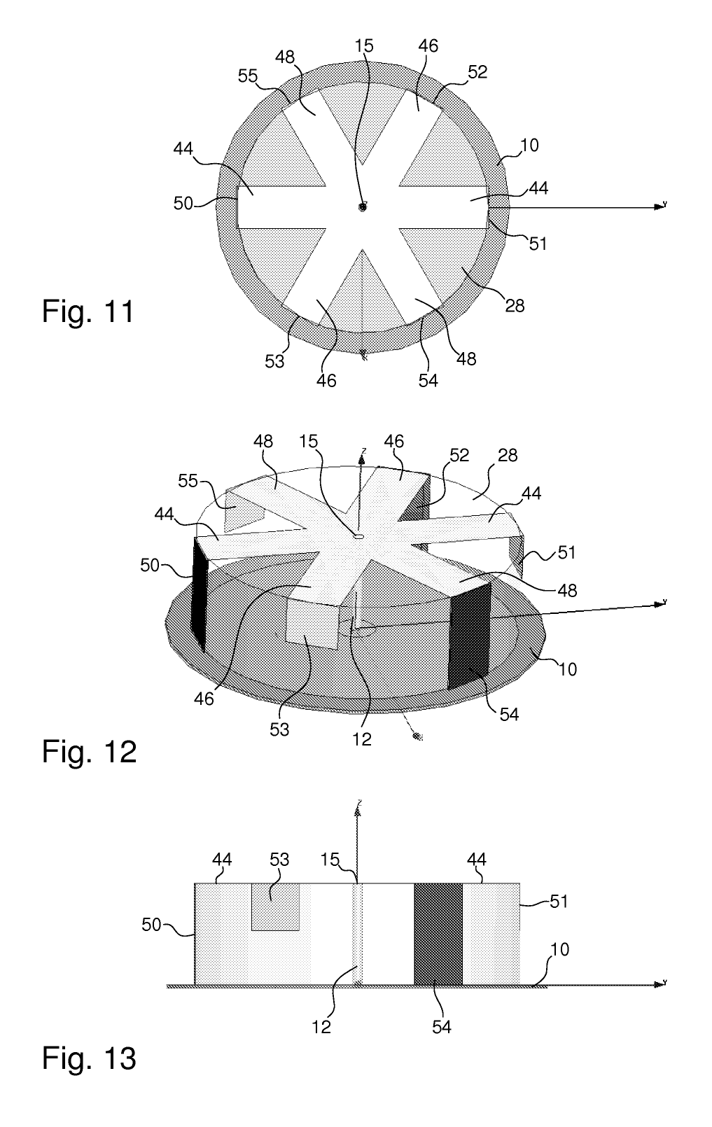

The further embodiment as illustrated in FIGS. 11, 12 and 13 shows a somewhat different design of transmission lines 44, 46, 48, each of which having a vertical interconnect 50, 52, 54 at one end section and a vertically bended open ended opposite end section 51, 53, 55. Furthermore, the overall design of a single transmission line 44, 46, 48 varies from the design of transmission lines 14, 16, 18 as depicted in FIGS. 9 and 10 in their width. These geometric variations both provide an impedance and frequency matching for the respective application purpose.

Comparable to the embodiment according to FIGS. 9 and 10, also the embodiment according to FIGS. 11 to 13 comprises a dielectric substrate 28, which is laterally confined by the vertically extending end sections 51, 53, 55, or VIA 50, 52, 54 of the transmission lines 44, 46, 48. As can be seen from FIG. 13, the vertical interconnect access 54 provides an electric coupling between the ground plane 10 and the transmission line 48. The bended and vertical extending open ended or open-circuit end section 53 points towards the ground plane 10 but leaves a gap.

Furthermore, as can be seen from FIGS. 11 to 13, in this embodiment, the ground plane 10, having a polygonal shape further comprises a lateral expansion exceeding the lateral expansion of the transmission lines 44, 46, 48 and the lateral expansion of the dielectric layer 28.

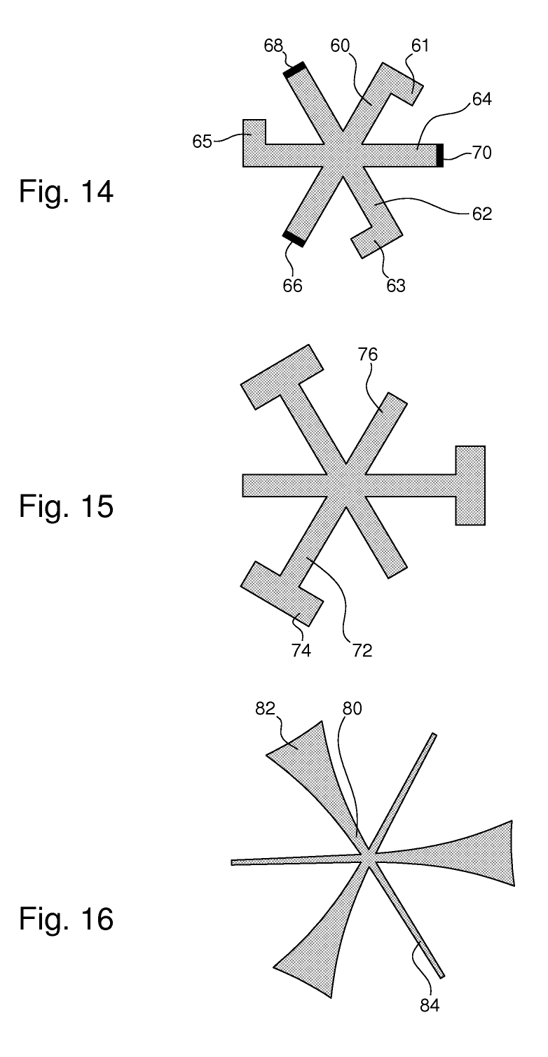

FIG. 14 further depicts another embodiment comprising three transmission lines 60, 62, 64 being open ended at end sections 61, 63, 65 and being coupled to the ground plane at opposite end sections 66, 68, 70. Due to this geometric structure, a frequency and/or impedance matching can be achieved without extending the lateral dimension of the overall antenna design.

FIG. 15 depicts another considerable geometric shape of a transmission line 72 being T-shaped at the open-circuit end 74 and being coupled to the ground plane at its opposite end 76.

FIG. 16 further depicts another embodiment with a transmission line 80 comprising a rather thin end section 84 being coupled to the ground plane and comprising a diverging or conical extending opposite end section 82 being open-circuit.

By means of a parallel or diverging open-circuit end section, reflexions in the transition to the enlarged part of the open ended microstrip can be reduced.

To summarize, by making use of a central feeding pin 15 and by means of sequentially rotated radiating elements rotating around this feeding point, a more symmetric radiation pattern regarding to azimuth can be obtained. By making use of a dielectric substrate between the irradiating elements and a ground plane, the overall size of the antenna can be reduced. Further, by making use of a grounded end section of each transmission line, the size of the antenna can be reduced together with a sufficiently good matching to a feeding network. Also, the proposed antenna structure provides an input impedance matched to the antenna with a large bandwidth compared to the size of the antenna. Finally, the directivity can be maximised between 20° to 60° of elevation and the obtained level is still sufficient near 0° of elevation for all azimuthal directions.

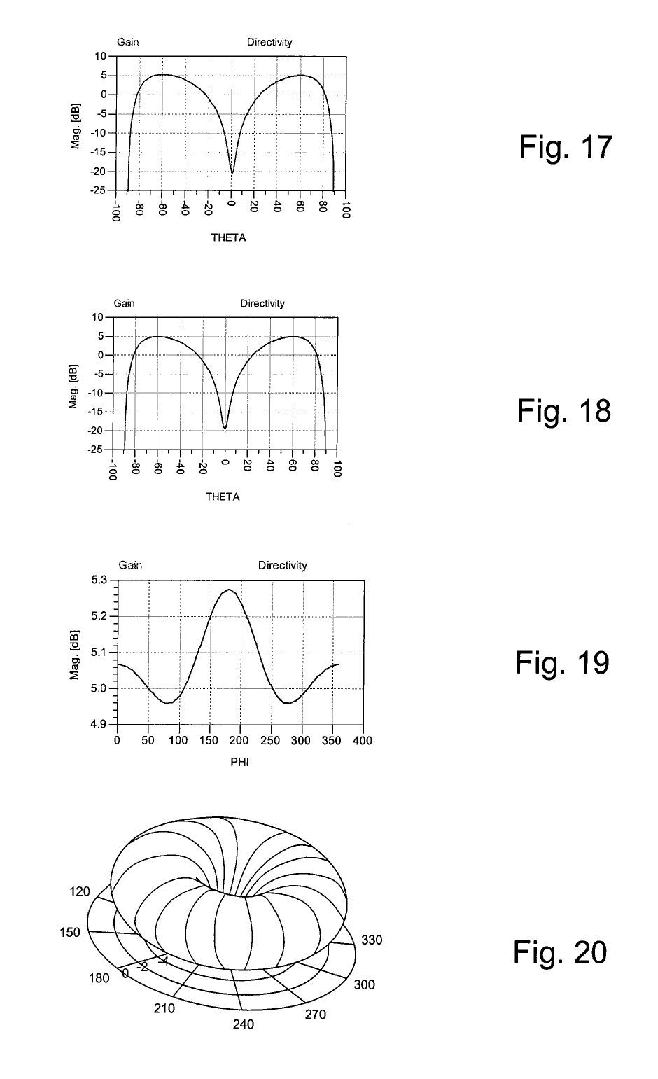

The major advantage of the developed antenna design is illustrative from FIGS. 17 to 20. As shown in FIGS. 17 and 18, the directivity at very high elevation angles between 70° and 90°, close to zenith direction and at very low angles, in particular less than 5°, which is close to the horizon, can be minimised.

The minimisation of the radiation pattern in these directions allows the level of directivity at medium and low ranges to be increased. In the presented examples of FIGS. 17 to 20, the directivity of the antenna can reach more than 5 dBil at 20° to 25° of elevation instead of less than 4 dBil for a typical PIFA antenna, as known in the prior art.

Furthermore, a more symmetric behaviour along azimuth, as illustrated in FIG. 19 can be reached, with a maximum variation of 0.3 dB as observed along a conical cut.

As can further be seen from the radiation pattern according to FIG. 20 at a 10 dB scale, the overall radiation pattern structure becomes doughnut-like and very regular.

While particular embodiments of the present invention have been illustrated and described, it would be obvious to those skilled in the art that various other changes and modifications can be made without departing from the spirit and scope of the invention. It is therefore intended to cover in the appended Claims all such changes and modifications that are within the scope of this invention

What is claimed is:

1. An antenna for mobile satellite communication including an electrically conducting ground plane and comprising at least a first and a second radiating element, being electrically coupled to a feed line, each one of said at least first and second radiating elements is at least indirectly electrically connected to the ground plane at one end and being open-circuit at an opposite end, whereby the at least first and second radiating elements intersect at a feeding point of the feed line and extend radially with respect to the elongation of the feed line.

2. The antenna according to claim 1, whereby the at least first and second radiating elements comprise an identical geometric shape and are oriented at an angle with respect to each other with the feed line as axis of rotation.

3. The antenna according to claim 1, whereby the relative angle between any two adjacently disposed radiating elements is determined by 180° divided by the number of radiating elements.

4. The antenna according to claim 1, whereby the radiating elements extend parallel to the ground plane.

5. The antenna according to claim 1, whereby the feed line is fed by means of a waveguide etched in the ground plane or by means of a microstrip line extending substantially parallel to the ground plane above or below the ground plane.

6. The antenna according to claim 1, whereby the feed line extends through an aperture of the ground plane.

7. The antenna according to claim 1, whereby the at least first and second radiating elements comprise larger outer dimensions at their open-circuit end portion compared to their opposite end portion being electrically connected to the ground plane.

8. The antenna according to claim 1, whereby the open-circuit end portion extend at an angle with respect to the elongation of the residual radiating element or with respect to the ground plane.

9. The antenna according to claim 1, whereby the space between the ground plane and the at least first and second radiating elements is filled with an at least first dielectric layer.

10. The antenna according to claim 1, whereby an at least second dielectric layer is disposed adjacent to an upper surface of the radiating elements facing away from the ground plane.

11. The antenna according to claim 1, whereby the ground plane or the radiating elements are embedded in the first or second dielectric layer.

12. The antenna according to claim 9, whereby the first and second dielectric layers and/or the ground plane comprise a cylindrical, circular or polygonal shape.

13. The antenna according to claim 1, whereby the electrical connection of the at least first and second radiating elements free end is provided by means of a Vertical Interconnect Access being embedded at least in the first dielectric layer or being adapted to laterally confine the first dielectric layer.
